(19) United States
(12) Patent Application Publication
(10) Pub. No.: US 2026/0061271 A1
(43) Pub. Date: Mar. 5, 2026

(54) NOVEL PICKLEBALL RACKET

(71) Applicant: AIREO SPORTS INC, SPOKANE, WA (US)

(72) Inventor: Liying CHEN, SPOKANE, WA (US)

(73) Assignee: AIREO SPORTS INC, SPOKANE, WA (US)

(21) Appl. No.: 18/921,879

(22) Filed: Oct. 21, 2024

(30) Foreign Application Priority Data
Sep. 5, 2024 (CN) 2024221780642

(51) Int. Cl. A63B 59/42; A63B 60/14; A63B 102/08; B32B 3/04; B32B 3/12; B32B 5/02; B32B 5/26; B32B 15/02; B32B 15/14

(52) U.S. Cl. CPC A63B 59/42; A63B 60/14; B32B 3/04; B32B 3/12; B32B 5/022; B32B 5/265; B32B 15/02; B32B 15/14; A63B 2102/08; A63B 2209/02; B32B 2250/05; B32B 2262/106; B32B 2307/744

(57) ABSTRACT

The present invention discloses a novel Pickleball racket, including a Pickleball racket body, where the Pickleball racket body includes a racket surface and a handle that are integrally connected, an inner multilayer carbon fiber cloth layer, an inner non-woven fabric layer, a honeycomb plate layer, an outer non-woven fabric layer, an outer titanium wire mesh layer, an outer multilayer carbon fiber cloth layer, and a surface carbon fiber layer are sequentially bonded on the racket surface from inside to outside; an edge of the racket surface is provided with a covered edge, and a height of the covered edge is not lower than that of the surface carbon fiber layer; a tongue portion is protruded from the inner multilayer carbon fiber cloth layer.

### CROSS-REFERENCE TO RELATED APPLICATIONS

The application claims priority to Chinese patent application No. 2024221780642, filed on Sep. 5, 2024, the entire contents of which are incorporated herein by reference.

### TECHNICAL FIELD

The present invention relates to a racket, an in particular, to a novel Pickleball racket.

### BACKGROUND

Pickleball is a sport of hitting a ball with a racket, which originated from Bainbridge Island in Seattle, USA. It is best understood as a combination of tennis, badminton and table tennis.

Compared to table tennis, Pickleball requires persons to put in a higher amount of physical activity and mobility, and therefore, it is better than table tennis in physical exercise. Compared to badminton and tennis, Pickleball requires the persons to put in a smaller amount of activity and exercise, and therefore, a person who has difficulty in playing badminton or tennis is suitable for playing Pickleball as a regular exercise project. Pickleball is suitable for all ages. Especially for those who have played tennis in the past but can no longer continue due to certain limitations (some jokingly call Pickleball “seniors' tennis”), or those who play table tennis or badminton and are looking for a more intense sport, Pickleball is an excellent choice. In addition, because the court and equipment required for Pickleball is cheaper than those for tennis, some people jokingly call Pickleball “poormen's tennis”.

When playing Pickleball, a Pickleball racket is required. The existing Pickleball

racket has defects that: after long-time hitting of the ball, the racket is easy to be damaged, which shows that the racket surface is damaged or loses its elastic force, the racket is easy to be broken, and the hitting power is insufficient.

### SUMMARY

The technical problem to be solved by the present invention is to provide a novel Pickleball racket according to the deficiencies of the prior art.

In order to realize the above purpose, the present invention adopts the following measures:

a novel Pickleball racket, including a Pickleball racket body, where the Pickleball racket body includes a racket surface and a handle that are integrally connected, an inner multilayer carbon fiber cloth layer, an inner non-woven fabric layer, a honeycomb plate layer, an outer non-woven fabric layer, an outer titanium wire mesh layer, an outer multilayer carbon fiber cloth layer, and a surface carbon fiber layer are sequentially bonded on the racket surface from inside to outside;

an edge of the racket surface is provided with a covered edge, and a height of the covered edge is not lower than that of the surface carbon fiber layer;

a tongue portion is protruded from the inner multilayer carbon fiber cloth layer, the inner non-woven fabric layer, the honeycomb plate layer, the outer non-woven fabric layer, the outer titanium wire mesh layer, the outer multilayer carbon fiber cloth layer, and the surface carbon fiber layer towards the handle, respectively, and the handle is sleeved with a fixed ring for fixing the tongue portion;

an outer portion of the handle is spirally wrapped with anti-slip layer; and

the surface carbon fiber layer is subjected to sand blasting treatment.

The present invention has the following beneficial effects: the Pickleball racket is practical, the structure is novel, resilience of the whole racket surface is improved by increasing the titanium wire mesh layer, hitting power is more sufficient, the racket is not easy to be broken, and the quality and grade of the product are improved.

### BRIEF DESCRIPTION OF THE DRAWINGS

The figure is a schematic structural exploded view of the present invention.

### DETAILED DESCRIPTION OF THE EMBODIMENTS

A novel Pickleball racket includes a Pickleball racket body 1, where the Pickleball racket body 1 includes a racket surface 101 and a handle 102 that are integrally connected, an inner multilayer carbon fiber cloth layer 11, an inner non-woven fabric layer 33, a honeycomb plate layer 44, an outer non-woven fabric layer 55, an outer titanium wire mesh layer 66, an outer multilayer carbon fiber cloth layer 77, and a surface carbon fiber layer 88 are sequentially bonded on the racket surface 101 from inside to outside.

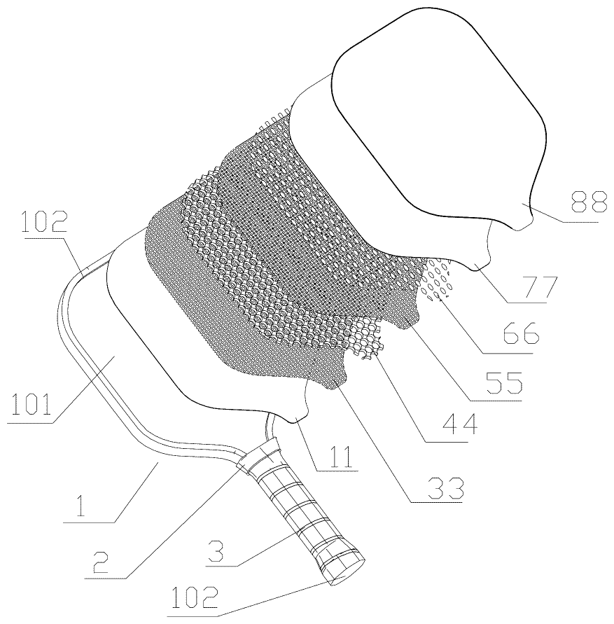

As shown in FIG. 1, according to the Pickleball racket provided by the scheme of the present invention, through the added outer titanium wire mesh layer 66, the whole racket surface 101 is more resilient when hitting the ball, and hitting power is more sufficient.

An edge of the racket surface 101 is provided with a covered edge 102, and a height of the covered edge 102 is not lower than that of the surface carbon fiber layer 88. The covered edge 102 helps to protect the edge of the racket surface 101 and edges of each layer from abrasion.

A tongue portion is protruded from the inner multilayer carbon fiber cloth layer 11, the inner non-woven fabric layer 33, the honeycomb plate layer 44, the outer non-woven fabric layer 55, the outer titanium wire mesh layer 66, the outer multilayer carbon fiber cloth layer 77, and the surface carbon fiber layer 88 towards the handle 102, respectively, and the handle 102 is sleeved with a fixed ring 2 for fixing the tongue portion. The connection between the racket surface 101 and the handle 102 is enhanced, the whole Pickleball racket is not easy to be broken and has higher strength, and the quality and grade of the Pickleball racket product are improved.

An outer portion of the handle 102 is spirally wrapped with anti-slip layer 103, so as to be comfortable to hold.

The surface carbon fiber layer 88 is subjected to sand blasting treatment.

What is claimed is:

1. A novel Pickleball racket, comprising a Pickleball racket body (1), wherein the Pickleball racket body (1) comprises a racket surface (101) and a handle (102) that are integrally connected, an inner multilayer carbon fiber cloth layer (11), an inner non-woven fabric layer (33), a honeycomb plate layer (44), an outer non-woven fabric layer (55), an outer titanium wire mesh layer (66), an outer multilayer carbon fiber cloth layer (77), and a surface carbon fiber layer (88) are sequentially bonded on the racket surface (101) from inside to outside.

2. The novel Pickleball racket according to claim 1, wherein an edge of the racket surface (101) is provided with a covered edge (102), and a height of the covered edge (102) is not lower than that of the surface carbon fiber layer (88).

3. The novel Pickleball racket according to claim 1, wherein a tongue portion is protruded from the inner multilayer carbon fiber cloth layer (11), the inner non-woven fabric layer (33), the honeycomb plate layer (44), the outer non-woven fabric layer (55), the outer titanium wire mesh layer (66), the outer multilayer carbon fiber cloth layer (77), and the surface carbon fiber layer (88) towards the handle (102), respectively, and the handle (102) is sleeved with a fixed ring (2) for fixing the tongue portion.

4. The novel Pickleball racket according to claim 3, wherein an outer portion of the handle (102) is spirally wrapped with anti-slip layer (3).

5. The novel Pickleball racket according to claim 1, wherein the surface carbon fiber layer (88) is subjected to sand blasting treatment.
